(19) United States
(12) Patent Application Publication
(10) Pub. No.: US 2007/0126974 A1
(43) Pub. Date: Jun. 7, 2007

(54) Liquid crystal display

(75) Inventors: Chi-Kuang Lai, Miao-Li (TW); Wen-Shan Chao, Miao-Li (TW); Chi-Yuan Lu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/633,277

(22) Filed: Dec. 4, 2006

(30) Foreign Application Priority Data
Dec. 2, 2005 (TW) 94142620

(51) Int. Cl. G02F 1/1333

(52) U.S. Cl. 349/161

(57) ABSTRACT

An example liquid crystal display (3) has a first substrate (31) and a second substrate (32) opposite to the first substrate; a liquid crystal layer (33) sandwiched between the first substrate and the second substrate; and a heating element (44) to heat the first and the second substrate.

### FIELD OF THE INVENTION

The present invention relates to a liquid crystal display, particularly relates to a liquid crystal display having a good display image in a low temperature circumstance.

### GENERAL BACKGROUND

Because liquid crystal display devices have the merits of being thin, light in weight, and drivable by a low voltage, they are extensively employed in various electronic devices.

A liquid crystal panel of an LCD device cannot itself emit light beams. Therefore a typical liquid crystal panel uses a backlight module to provide the needed illumination. The backlight module has a light source and a light guide plate. The light source emits the light beams to the light guide plate, which then transmits the light beams to illuminate the liquid crystal panel.

A typical LCD device 100 as shown in FIG. 3 includes a liquid crystal panel 10 and a backlight module 20 provided under the liquid crystal panel 10. The liquid crystal panel 10 has a first substrate 11, a second substrate 12, and a liquid crystal layer 13 interposed between the first and second substrates 11, 12.

The backlight module 20 has a light source 21 and a light guide plate 22, which the light source 21 faces the light guide plate 22. Light beams from the light source 21 enters into the light guide plate 22, which the light guide plate 22 functions to change a direction of propagation of light beams emitted from the light source 21 and introduced into the light guide plate 22, from a direction roughly parallel to an emission face of the light guide plate 22 to a direction perpendicular to the emission face. That is, the light guide plate 22 effectively changes the linear or point light source(s) into a surface light source, for evenly illuminating a whole display screen of the liquid crystal panel 10. Light beams illuminating the liquid crystal panel 10 can be controlled to pass the liquid crystal panel 10 to realize the image display through controlling the rotating of the liquid crystal molecular in the liquid crystal layer 13.

The light source 21 may be a linear light source, such as a cold cathode fluorescent lamps (CCFL), or one or more point light sources, such as light emitting diodes (LEDs).

However, when the LCD 1 is used in a low temperature circumstance, the liquid crystal molecular in the liquid crystal layer 13 is influenced by the low temperature. When the circumstance temperature is lower than the operation temperature of the liquid crystal molecular, the response speed of the LCD device 100 is lowered, which influences the display characteristic, especially reduces the contrast ratio and produces mura phenomenon.

What is needed, therefore, is a liquid crystal display that overcomes the above-described deficiencies.

### SUMMARY

In a preferred embodiment, an liquid crystal display has a first substrate and a second substrate opposite to the first substrate; a liquid crystal layer sandwiched between the first substrate and the second substrate; and a heating element to heat the first and the second substrate in a low temperature circumstance.

Other advantages and novel features will become more apparent from the following detailed description when taken in conjunction with the accompanying drawings.

### BRIEF DESCRIPTION OF THE DRAWINGS

FIG. 1 is a schematic view of a liquid crystal display according to a first embodiment of the present invention, which has a first substrate and a color filter.

FIG. 2 is a partly enlarged view of the first substrate of FIG. 1, a color filter being formed thereon.

FIG. 3 is a schematic view of a conventional liquid crystal display device.

### DETAILED DESCRIPTION OF PREFERRED EMBODIMENTS

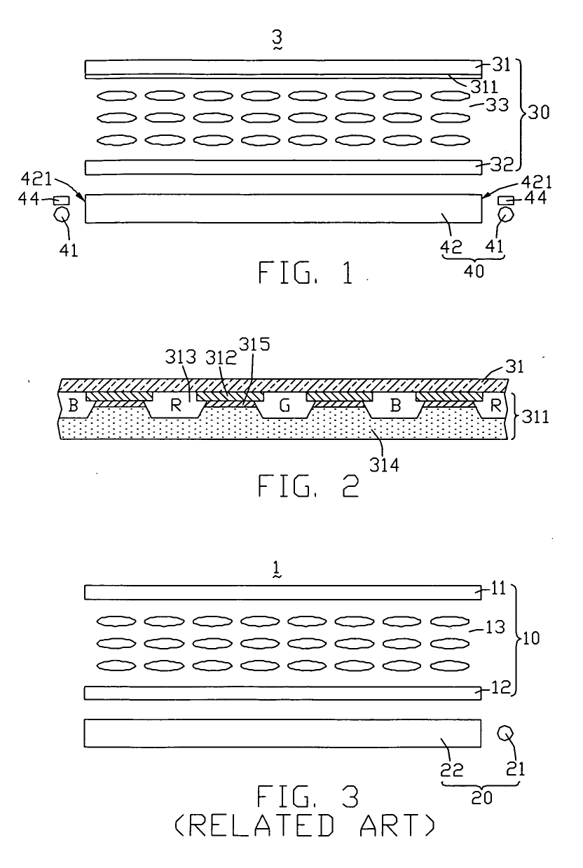

FIG. 1 shows a schematic view of a liquid crystal panel according to a first embodiment of the present invention. The liquid crystal display 3 has a liquid crystal panel 30 and a backlight module 40 disposed under the liquid crystal display 3 for providing light beams thereto.

The liquid crystal panel 30 has a first substrate 31, a second substrate 32 opposite to the first substrate 31, a liquid crystal layer 33 sandwiched between the first and the second substrates 31, 32. A color filter plate 311 is disposed on the first substrate 31, between the first substrate 31 and the liquid crystal layer 33.

The backlight module 40 has a plurality of light sources 41 and a light guide plate 42, which the light guide plate 42 has two light incident surfaces 421 opposite to each other, the plurality of light sources 41 being opposite to the light incident surfaces 421, respectively. Light beams from the light sources 41 enters into the light guide plate 42 through the two light incident surfaces 421, respectively, and transmits into the liquid crystal panel 30. The liquid crystal panel 30 controls the transmittance of light beams for displaying image through controlling the rotation of the liquid crystal molecular in the liquid crystal layer 33.

The light source 41 generally is a linear light source, such as a cold cathode fluorescent lamps (CCFL), or one or more point light sources, such as light emitting diodes (LEDs).

The liquid crystal display 3 further has at least one heating element 44 and a heat sensor (not shown) connecting with the heating element 44, which the at least one heating element 44 is adjacent to the light incident surface 421 of the light guide plate 42. The heating element 44 is an infrared ray lamp or an infrared ray LED. The heat sensor can detect the temperature of the liquid crystal panel 30. When the heat sensor detects that the temperature of the liquid crystal panel 30 is lower, the heat sensor sends a signal to drive the at least one heating element 44 to emit infrared ray, which the infrared ray transmits into the light guide plate 42 and is guided into the liquid crystal panel 30 by the light guide plate 42, with the light beams from the light source 41 together.

Referring to FIG. 3, the color filter 311 has a black matrix (BM) 312, a color filter layer 313 and a protective layer 314. The black matrix 312 for shielding unnecessary light among the light irradiated from the second substrate 32 is provided in a matrix form. On the black matrix 312, the color filter layer 313 for displaying an image in colors is provided. The color filter layer 313 is composed of R, G, and B sub color filter layers each corresponding to one of unit pixel regions, alternately disposed between the black matrix 312. The protective layer 314 covers the black matrix 312 and the color filter layer 313. In addition, the color filter 311 further has an infrared ray absorption layer 315, which is formed between the black matrix 312 and the protective layer 314. The absorption layer 315 is made from an inorganic infrared ray absorption material, which can absorb the heat energy of the infrared ray from the heating element 44 to heat the whole panel of the liquid crystal panel 30 and improve the temperature of the liquid crystal layer 33. Thus, the liquid crystal display 3 can keep a good display quality even though in a lower temperature environment. The absorption layer 315 can be made from HgCdTe, InSb, or PtSi.

In an alternative embodiment, the liquid crystal panel can utilize an organic infrared ray absorption material doped in the color filter 313 or the protective layer 314 to replace the absorption layer 315. The doped color filter 313 or the doped protective layer 314 also can absorb the heat energy of the infrared ray from the heating element 44 to heat the whole panel of the liquid crystal panel 30 and improve the temperature of the liquid crystal layer 33.

The liquid crystal display 3 utilize a heating element 44 and a color filter 311 having an infrared ray absorption material formed therein to heat the liquid crystal layer 33 and keep a good displaying quality in a lower temperature environment.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a first substrate and a second substrate opposite to the first substrate;
a liquid crystal layer sandwiched between the first substrate and the second substrate;
a heating element to heat the first and the second substrate in a low temperature circumstance.

2. The liquid crystal display as claimed in claim 1, wherein the heating element is an infrared ray lamp.

3. The liquid crystal display as claimed in claim 1, wherein the heating element is an infrared ray light emitting diode.

4. The liquid crystal display as claimed in claim 1, further comprising a light guide plate at one side of the second substrate and at least one light source, the light guide plate having at least one incident surface, opposite to the at least one light source.

5. The liquid crystal display as claimed in claim 1, wherein the heating element is adjacent to the at least one incident surface.

6. The liquid crystal display as claimed in claim 1, further comprising a color filter disposed between the first substrate and the liquid crystal layer.

7. The liquid crystal display as claimed in claim 6, wherein the color filter comprises a black matrix, a color filter layer and a protective layer.

8. The liquid crystal display as claimed in claim 7, wherein the color filter layer comprises R, Q and B sub color filter layers each corresponding to one of unit pixel regions, alternately disposed between the black matrix.

9. The liquid crystal display as claimed in claim 7, wherein the protective layer covers the black matrix and the color filter.

10. The liquid crystal display as claimed in claim 7, wherein the color filter further comprises an absorption layer disposed between the black matrix and the protective layer.

11. The liquid crystal display as claimed in claim 10, wherein the absorption layer is made from an inorganic infrared ray absorption material.

12. The liquid crystal display as claimed in claim 11, wherein the absorption material is one of the HgCdTe, InSb, and PtSi.

13. The liquid crystal display as claimed in claim 7, wherein an organic infrared ray absorption material is doped in the color filter layer of the protective layer.

14. The liquid crystal display as claimed in claim 1, further comprising a sensor detecting the circumstance temperature, which sends a signal to the heating element to heat the first and the second substrate when it detects the circumstance temperature is low.

15. A method of making liquid crystal display, comprising steps of:
providing a first substrate and a second substrate opposite to the first substrate;
disposing a liquid crystal layer sandwiched between the first substrate and the second substrate;
providing a light guide plate facing the firs substrate and the second substrate;
providing a light source beside said light guide plate;
applying a heating element around the least one of said first substrate and said second substrate to heat at least one of the first and the second substrate in a low temperature circumstance.

16. The method as claimed in claim 15 wherein said heat element is located horizontally beside said light guide plate.

17. A liquid crystal display, comprising:
a first substrate and a second substrate opposite to the first substrate;
a liquid crystal layer sandwiched between the first substrate and the second substrate;
a light guide plate facing said second substrate opposite to the first substrate;
at least one light source located beside said light guide plate to generate light beams;
at least one heating element located around an assembly of said first substrate, the second substrate and the liquid crystal layer, so as to efficiently heat the first and the second substrate in a low temperature circumstance.

18. The liquid crystal display as claimed in claim 17, wherein the heating element is operated disregarding whether the at least one light source is on or not.

19. The liquid crystal display as claimed in claim 17, wherein the at least one light sourced and the at least one heating element is discrete from while close to each other.
